(19) United States
(12) Patent Application Publication
(10) Pub. No.: US 2004/0244005 A1
(43) Pub. Date: Dec. 2, 2004

(54) Automatic urgency calculator and task scheduler

(76) Inventor: Leland J. Ancier, Rancho Santa Fe, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/449,990

(22) Filed: May 30, 2003

(51) Int. Cl. G06F 9/46

(52) U.S. Cl. 718/103

(57) ABSTRACT

A prioritization manager processes a plurality of tasks, each task having a plurality of associated qualities, at least some qualities having an assigned value and an associated weight. The prioritization manager automatically calculates an urgency for at least some of the tasks, based on the assigned values and associated weights of at least some of the associated qualities. The prioritization manager automatically creates a structured output based on the calculated urgencies of the tasks. The structured output can comprise a prioritized task list. The structured output can comprise a calendar.

### BACKGROUND

1. Field of Invention

The present invention relates generally to automatic task scheduling, and more specifically to automatically calculating the urgency of tasks, and automatically creating prioritized task lists and schedules based on the calculated urgencies.

2. Background of Invention

In today's fast paced society, the efficient scheduling of tasks is more important than ever. Although making “to do” lists helps with task management, such lists are often outdated as soon as they are drafted. The frequent manual updating of such lists can be a substantial task itself. Furthermore, frequently updated task lists can quickly become disorganized. Pocket calendars, appointment books and similar products can help with organization, but still require frequent, time intensive, manual updating.

Some software programs allow maintenance of an electronic task list or calendar on a personal or handheld computer. Such systems are merely electronic versions of their paper predecessors. Although using an electronic task list or calendar allows for more efficient organization than the paper equivalent, these products do not help their users to actually prioritize tasks, based on their urgency or qualities. Different tasks have different urgencies, and have different qualities, such as difficulty, importance, type, priority, deadline, required time to complete and completed percentage. What is needed are methods, computer program products and systems for automatically prioritizing tasks, based on their urgency and qualities.

### SUMMARY OF INVENTION

A prioritization manager processes a plurality of tasks, each task having a plurality of associated qualities, at least some qualities having an assigned value and an associated weight. The prioritization manager automatically calculates an urgency for at least some of the tasks, based on the assigned values and associated weights of at least some of the associated qualities. The prioritization manager automatically creates a structured output based on the calculated urgencies of the tasks. In some embodiments, the prioritization manager receives an update concerning a task from a user, and automatically recalculates the urgency for that task based on the update. In those embodiments, the prioritization manager automatically recreates the structured output based on the recalculated urgency. In some embodiments, the structured output is in the form of a prioritized task list. In other embodiments, the structured output is in the form of a plotted time grid.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is a block diagram illustrating a high level overview of a system for practicing some embodiments of the present invention.

FIG. 2 is a block diagram illustrating a task, according to some embodiments of the present invention.

FIG. 3 is a flowchart illustrating steps for performing some embodiments of the present invention.

FIG. 4 is a flowchart illustrating steps for automatically creating a prioritized task list, according to some embodiments of the present invention in which the prioritized task list comprises a subset of the plurality of tasks.

FIG. 5 is a flowchart illustrating steps for automatically recreating a prioritized task list responsive to a task status being updated, according to some embodiments of the present invention.

FIG. 6 is a block diagram illustrating a high level overview of a system for practicing some embodiments of the present invention, in which the structured output based on the calculated urgencies of tasks comprises a plotted time grid.

FIG. 7 is a flowchart illustrating steps for performing some embodiments of the present invention in which the structured output based on the calculated urgencies of tasks comprises a plotted time grid.

FIG. 8 is a flowchart illustrating steps for automatically re-plotting tasks to the time grid, responsive to a task status being updated, according to some embodiments of the present invention.

FIG. 9 is a flowchart illustrating steps for performing other embodiments of the present invention that include a time grid.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF EMBODIMENTS

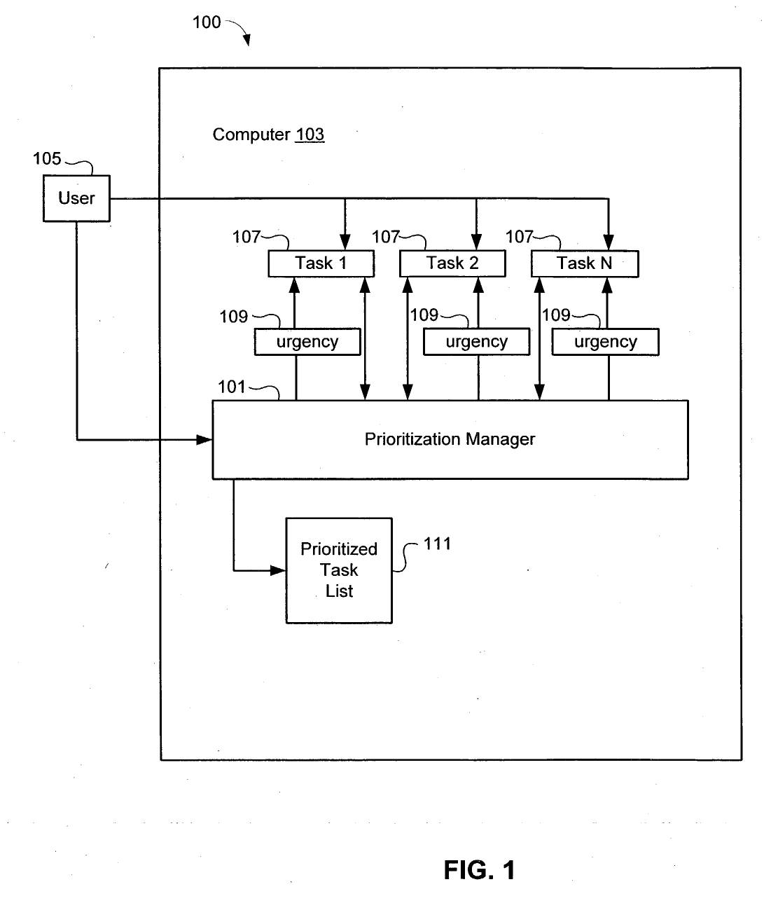

FIG. 1 illustrates a high level overview of a system 100 for practicing some embodiments of the present invention. A prioritization manager 101 runs in a computer 103. It is to be understood that although the prioritization manager 101 is illustrated as a single entity, as the term is used herein a prioritization manager 101 refers to a collection of functionalities which can be implemented as software, hardware, firmware or any combination of the three. Where a prioritization manager 101 is implemented as software, it can be implemented as a standalone program, but can also be implemented in other ways, for example as part of a larger program, as a plurality of separate programs, or as one or more statically or dynamically linked libraries. In some embodiments the prioritization manager 101 is implemented as a component of a software program which can run on a user's 105 computer 103, as illustrated in FIG. 1. In other embodiments, the functionalities performed by the prioritization manager 101 are distributed between multiple computers 103, such as a client and a server.

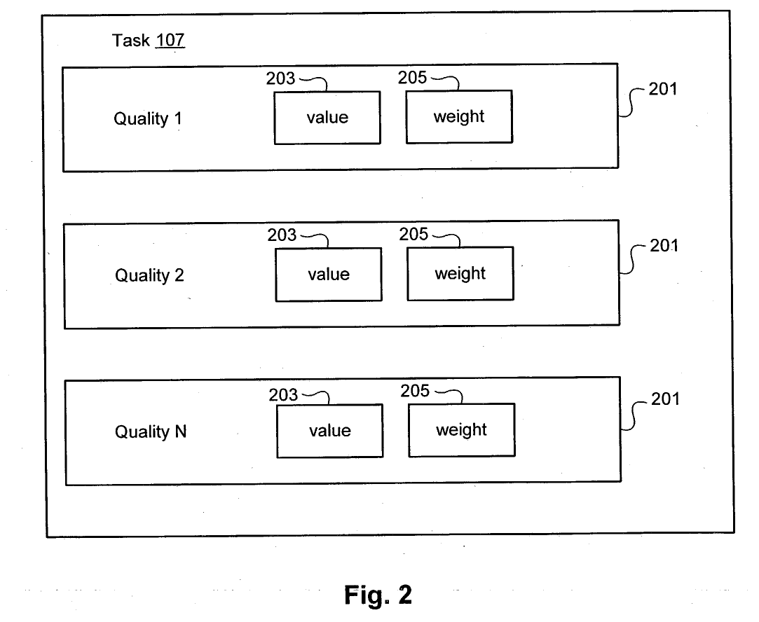

The prioritization manager 101 processes a plurality of tasks 107. An example task 107 is illustrated by FIG. 2. As FIG. 2 illustrates, a task 107 has a plurality of qualities 201. A quality 201 can have an assigned value 203, and an associated weight 205. A task 107 can be anything the user 105 needs to schedule, for example preparing a presentation for work, mowing the yard, attending a lecture, meeting a friend for lunch having the oil changed, etc. A quality 201 is some property affecting the task 107 or the performance thereof, such as the difficulty, importance, type, priority, deadline, length or completed percentage of the task 107. Other examples of task 107 qualities will be apparent to those of ordinary skill in the relevant art, in light of this specification.

A value 203 assigned to a task 107 quality 201 is a quantification and/or qualification of that quality 201. For example, for the task 107 “mow the lawn,” the quality 201 of difficulty could be assigned a value 203 of three on a scale of one to ten, whereas the quality 201 of importance could be assigned a five. Of course, in various embodiments some or all values 203 are measured in scales other than one to ten, or in formats other than scalar or numerical. For example, the quality 201 of length could be assigned a value 203 comprising a specific number of minutes (or, e.g., hours or days), whereas the quality of type could be assigned a value comprising a character string denoting a verbal description of a task 107 type, e.g., “employment task.” Many formats for quantifying and/or qualifying various qualities 201 are possible, and all are within the scope of the present invention. Finally, a weight 205 associated with a task 107 quality 201 is a quantification of the importance to be given to that quality 201 when scheduling the task 107. Various formats are possible (e.g., a numerical scale of zero to 100), the implementation mechanics of which will be readily apparent to those of ordinary skill in the relevant art, in light of this specification.

In some embodiments, some or all tasks 107 are provided as defaults by the system 100. In some embodiments default tasks 107 can be modified by the user 105 as desired. In some embodiments, some or all of the tasks 107 are provided by the user 105. In some embodiments, some or all qualities 201 are provided as defaults by the system 100, and automatically associated with some or all tasks 107 by the prioritization manager 101. In some embodiments default qualities 201 provided by the system 100 can be modified by the user 105 as desired. In some embodiments, some or all of the qualities 201 are provided and associated with tasks 201 by the user 105. Likewise, values 203 can be assigned to qualities 201 by the prioritization manager 101, and/or by the user 105. In some embodiments in which values 203 are assigned to qualities 201 by the prioritization manager 101, the values 203 can subsequently be edited by a user 105. Similarly, weights 205 can be associated with qualities 201 by the prioritization manager 101, and/or assigned and/or edited by the user 105.

The implementation mechanics for the system 100 supplying default tasks 107, qualities 201, values 203 and weights 205 (as well as other features described herein) will be readily apparent to those of ordinary skill in the relevant art in light of this specification. Likewise, the implementation mechanics for a user 105 supplying and/or editing qualities 201, values 203 and weights 205 will be readily apparent to ordinarily skilled artisans in light of this specification. For example, a user 105 can enter or edit features via a graphical user 105 interface, a command line or a configuration file.

Returning to FIG. 1, the prioritization manager 101 automatically calculates an urgency 109 for at least some of the tasks 107 of the plurality, based on the assigned values 203 and associated weights 205 of at least some of the associated qualities 201. In some embodiments, the prioritization manager 101 automatically calculates an urgency 109 for each task 107, and in others only for a subset of the tasks 107, depending upon which tasks 107 the user 105 is interested in scheduling. Which qualities 201 to use in order to calculate which urgencies 109 is determined by what criteria are to be used to prioritize the tasks 107. In some embodiments all qualities 201 are used, and in others only a subset, as desired. Which qualities 201 to use is a variable design choice, which can be determined by the user 105, or by a system administrator or designer. In some embodiments, the qualities 201 to use are provided by the user 105, and in other embodiments a set of default qualities 201 is provided by the system 100.

Once the qualities 201 to use are determined, the values 203 and weights 205 are used to calculate urgencies 109. In other words, the urgency 109 of a task is determined based upon the weighted 205 values 203 of the desired qualities 201 of that task 107. The implementation mechanics of such calculation will be readily apparent to one of ordinary skill in the relevant art, in light of this specification. A variety of formats for representing urgencies 109 will be apparent to those of ordinary skill in the relevant art in light of this specification, all of which are within the scope of the present invention.

The prioritization manager 101 automatically creates a prioritized task list 111 based on the calculated urgencies 109 of the tasks 107. In other words, the prioritization manager 101 automatically drafts a to do list reflecting the varying prioritization of the tasks 107 based on their urgencies 109. A variety of formats for the prioritized task list 111 will be apparent to those of ordinary skill in the relevant art in light of this specification, all of which are within the scope of the present invention. In some embodiments, the prioritization manager 101 automatically creates a structured output other than a prioritized task list 111. Some examples are discussed in more detail below.

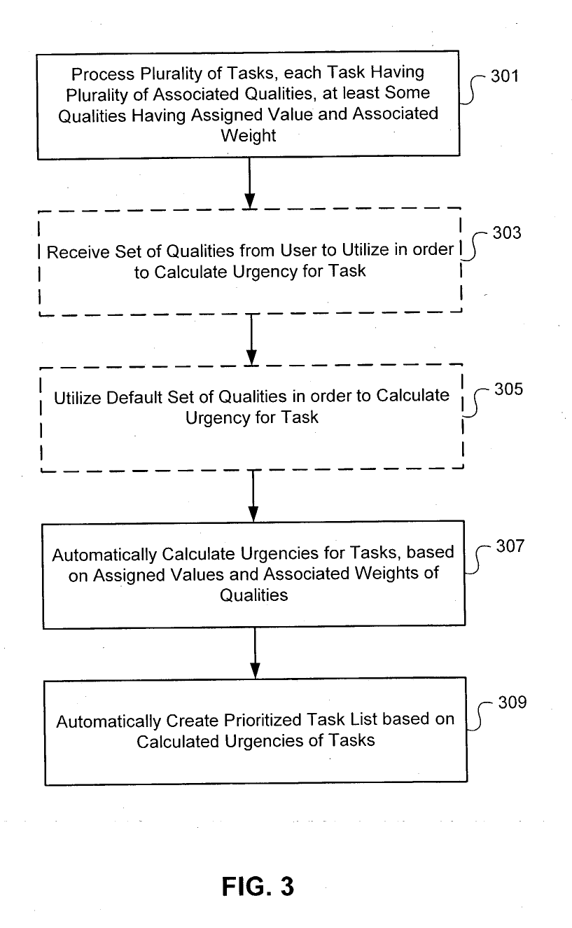

FIG. 3 illustrates steps for performing some embodiments of the present invention. The prioritization manager 101 processes 301 a plurality of tasks 107, each task 107 having a plurality of associated qualities 201, at least some qualities 201 having an assigned value 203 and an associated weight 205. Sometimes, the prioritization manager 101 receives 303 from the user 105 a set of qualities 201 to utilize in order to calculate 307 an urgency 109 for a task 107. In other instances, the prioritization manager 101 utilizes 305 a default set of qualities 201 in order to calculate 307 an urgency 109 for a task 107. Regardless, the prioritization manager 101 automatically calculates 307 an urgency 109 for a task 107, based on the assigned values 203 and associated weights 205 of at least some of the associated qualities 201. Once the prioritization manager 101 has calculated 307 an urgency 109 for each task 107 of interest, the prioritization manager 101 automatically creates 309 a prioritized task list 111 based on the calculated urgencies 109.

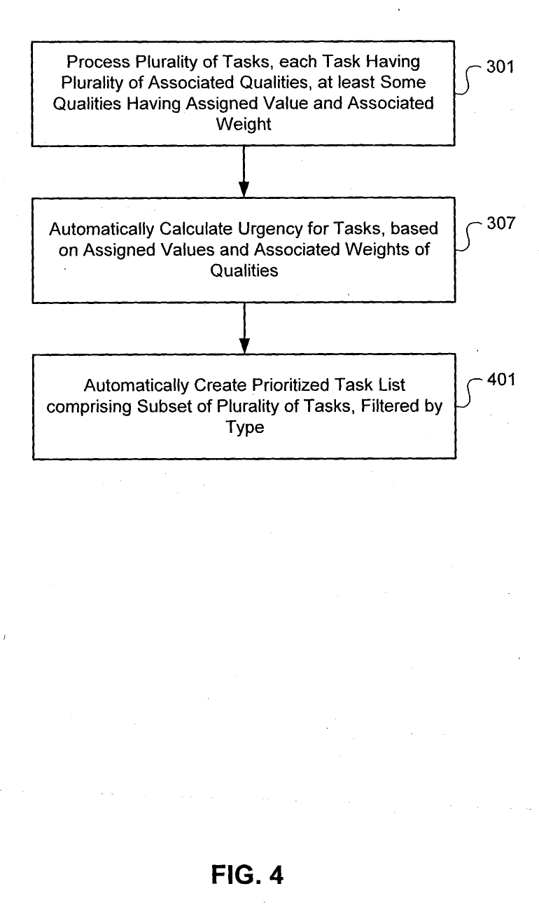

FIG. 4 illustrates steps for automatically creating 309 a prioritized task list 111, according to some embodiments of the present invention in which the prepared prioritized task list 111 comprises a subset of the plurality of tasks 107. As explained above, the prioritization manager 101 processes 301 a plurality of tasks 107, each task 107 having a plurality of associated qualities 201, at least some qualities 201 having an assigned value 203 and an associated weight 205. Subsequently, the prioritization manager 101 automatically calculates 307 an urgency 109 for at least some of the tasks 107, based on the assigned values 203 and associated weights 205 of at least some of the associated qualities 201. Then, the prioritization manager 101 automatically creates 401 a prioritized task list 111 comprising a subset of the plurality of tasks 107, filtered by type. In other words, the prioritization manager 101 automatically creates 401 a prioritized task list 111 that includes only tasks of a certain type, for example employment tasks, home tasks, school tasks or personal tasks. Of course, other subsets can be utilized as desired. In any case, prioritized task lists 111 comprising subsets of tasks 107 filtered by type allow a user 105 to view only specific tasks relevant to a desired scheduling analysis.

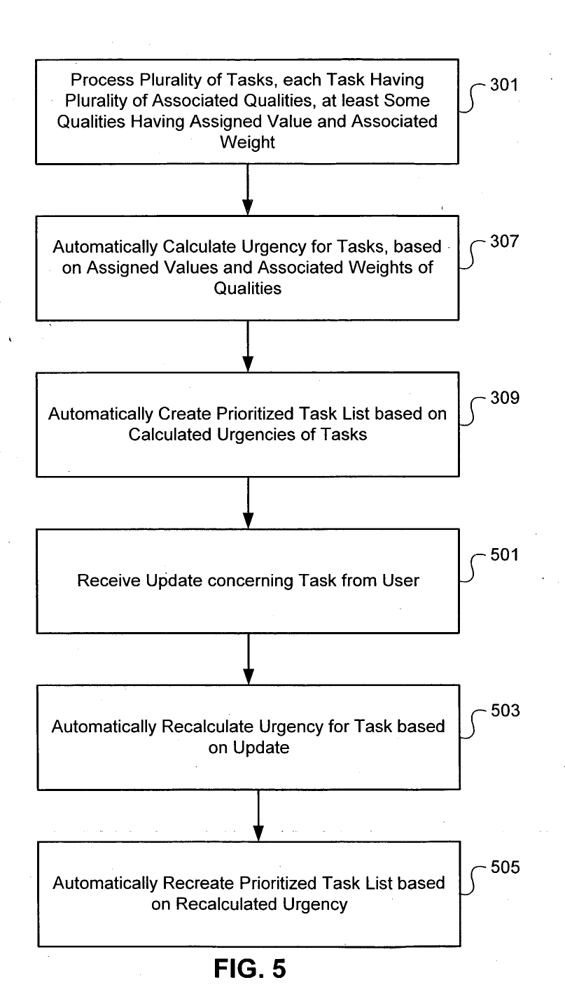

FIG. 5 illustrates steps for automatically recreating 505 a prioritized task list 111 responsive to a task 107 status being updated, according to some embodiments of the present invention. As described above in the discussion of FIG. 3, the prioritization manager 101 processes 301 a plurality of tasks 107, each task 107 having a plurality of associated qualities 201, at least some qualities 201 having an assigned value 203 and an associated weight 205. The prioritization manager 101 automatically calculates 307 an urgency 109 for each task 107 of interest, based on assigned values 203 and associated weights 205 of at least some of the associated qualities 201. Then, the prioritization manager 101 automatically creates 309 a prioritized task list 111 based on the calculated urgencies 109.

The prioritization manager 101 then receives 501 an update concerning a task 107 from the user 105. For example, the user could input an update indicating, for example, that a specific task 107 is now complete, or 75% complete, or that the user 105 worked on the task for five hours, or that the task 107 is now more (or less) important (other examples will be apparent to ordinarily skilled artisans in light of this specification). The prioritization manager 101 proceeds to automatically recalculate 503 the urgency 109 for the task 107, based on the updated status. The prioritization manager 101 then automatically recreates 505 the prioritized task list 111 based on the recalculated urgency 109 of the task 107 with the updated status.

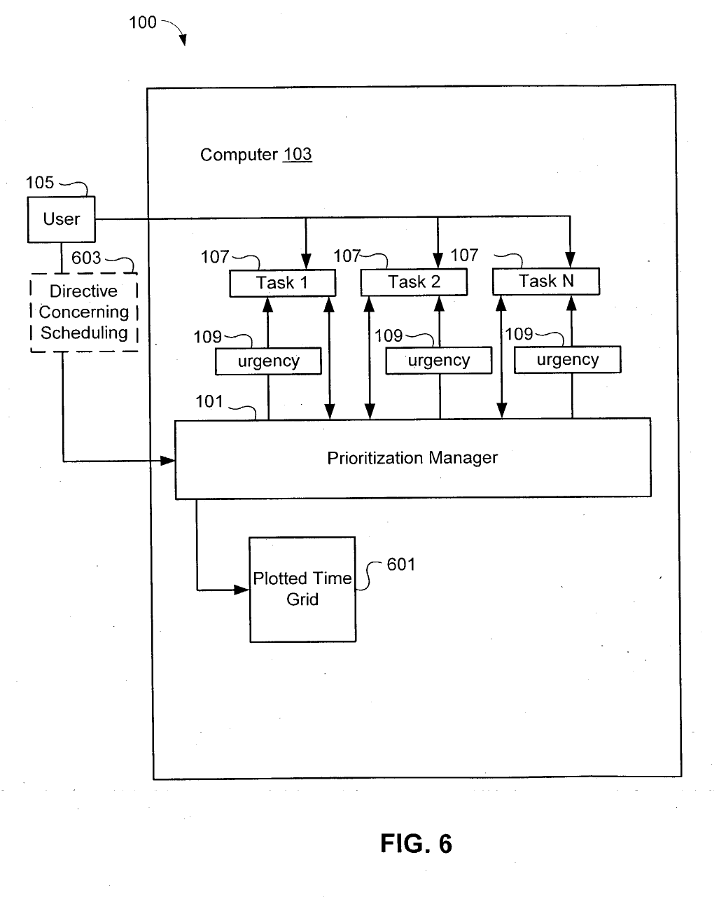

FIG. 6 illustrates a high level overview of a system 100 for practicing other embodiments of the present invention, in which the structured output based on the calculated urgencies 109 of tasks comprises a plotted time grid 601, as opposed to a prioritized task list 111. As with the embodiments illustrated in FIG. 1, a prioritization manager 101 processes a plurality of tasks 107, each task 107 having a plurality of associated qualities 201, at least some qualities 201 having an assigned value 203 and an associated weight 205. The prioritization manager 101 automatically calculates an urgency 109 for at least some of the tasks 107, based on the assigned values 203 and associated weights 205 of at least some of the associated qualities 201. However, rather than creating a prioritized task list 111, the prioritization manager 101 automatically plots tasks 107 to a time gird 601, based on the lengths of the tasks 107 and their respective urgencies 109. The plotted time grid 601 is essentially an automatically generated calendar, with tasks 107 allocated to appropriate times. The time grid 601 can be displayed to the user 105 according to various time frames as desired, e.g., daily, weekly, monthly, etc. In some embodiments, one or more tasks 107 are designated as being recurring tasks 107, in which case the prioritization manager 101 automatically plots them to the time grid 601 accordingly. Designation of a task 107 as being recurring can be by the user 105 or system 100 as desired.

In various embodiments, certain types of tasks 107 are only allocated to certain times of the day, or to certain days, as desired. For example, it could be desirable to never allocate work related tasks 107 to times before 8:00 a.m. or after 6:30 p.m., or to not allocate personal tasks 107 to business hours during the week. In some embodiments, some times are blocked off as being unavailable for scheduling of all tasks 107 (e.g., Friday night, Sunday morning, midnight to 7:00 a.m.). In some embodiments, certain tasks 107 are specifically allocated to certain days or times. Directives 603 concerning task 107 scheduling such as the ones described above can be provided by the system 100 as defaults, and/or provided and/or edited by the user 105, as desired. Various examples of such directives 603 will be apparent to those of ordinary skill in the relevant art in light of this specification. Furthermore, the implementation mechanics for allocating tasks 107 to times based on task 107 length and urgency 109 (and taking into account any scheduling directives 603) will be readily apparent to one of ordinary skill in the relevant art, in light of this specification.

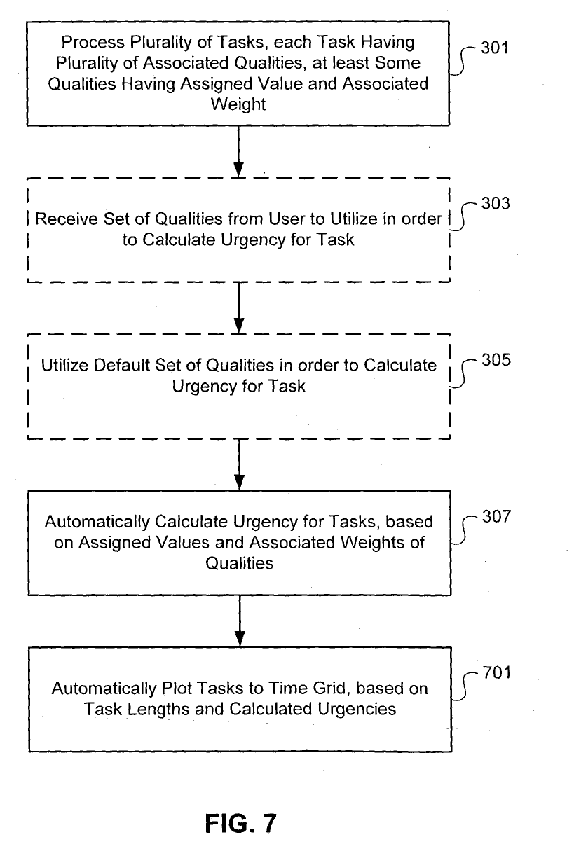

FIG. 7 illustrates steps for performing some embodiments of the present invention in which the structured output based on the calculated urgencies 109 of tasks comprises a plotted time grid 601. As illustrated in FIG. 3, the prioritization manager 101 processes 301 a plurality of tasks 107, each task 107 having a plurality of associated qualities 201, at least some qualities 201 having an assigned value 203 and an associated weight 205. Sometimes, the prioritization manager 101 receives 303 from the user 105 a set of qualities 201 to utilize in order to calculate 307 an urgency 109 for a task 107. In other instances, the prioritization manager 101 utilizes 305 a default set of qualities 201 in order to calculate 307 an urgency 109 for a task 107. Regardless, the prioritization manager 101 automatically calculates 307 an urgency 109 for a task 107, based on the assigned values 203 and associated weights 205 of at least some of the associated qualities 201. Then, the prioritization manager 101 automatically plots 701 tasks 107 to a time grid, based on lengths of the tasks 107 and the calculated urgencies 109.

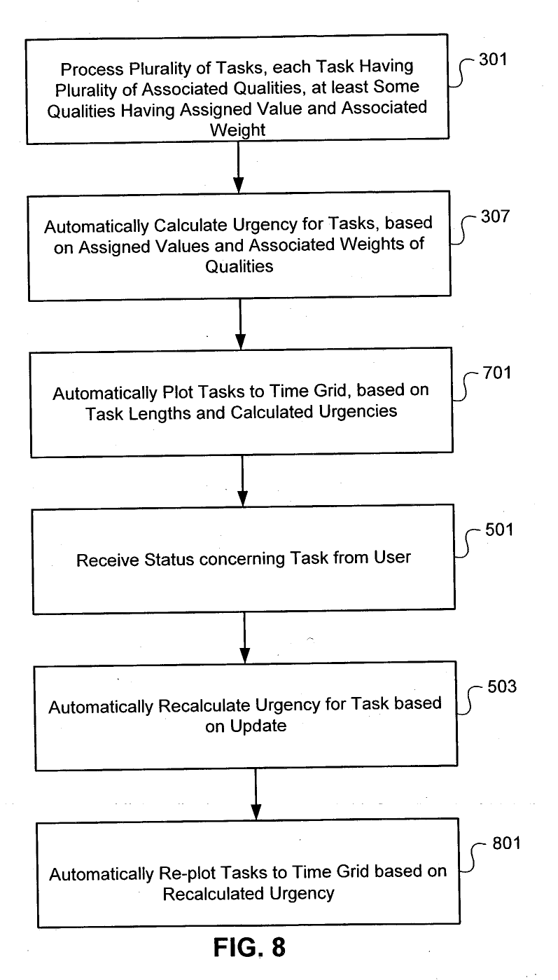

FIG. 8 illustrates steps for automatically re-plotting 801 tasks 107 to the time grid 601, responsive to a task 107 status being updated, according to some embodiments of the present invention. As described above in the discussion of FIG. 3, the prioritization manager 101 processes 301 a plurality of tasks 107, each task 107 having a plurality of associated qualities 201, at least some qualities 201 having an assigned value 203 and an associated weight 205. The prioritization manager 101 automatically calculates 307 an urgency 109 for each task 107 of interest, based on assigned values 203 and associated weights 205 of at least some of the associated qualities 201. Then, the prioritization manager 101 automatically plots 701 tasks 107 to a time grid, based on lengths of the tasks 107 and the calculated urgencies 109.

Then, as described above in the discussion of FIG. 5, the prioritization manager 101 then receives 501 an update concerning a task 107 from the user 105. The prioritization manager 101 proceeds to automatically recalculate 503 the urgency 109 for the task 107, based on the updated status. The prioritization manager 101 then automatically re-plots 801 tasks 107 to the time grid 601, based on the recalculated urgencies 109.

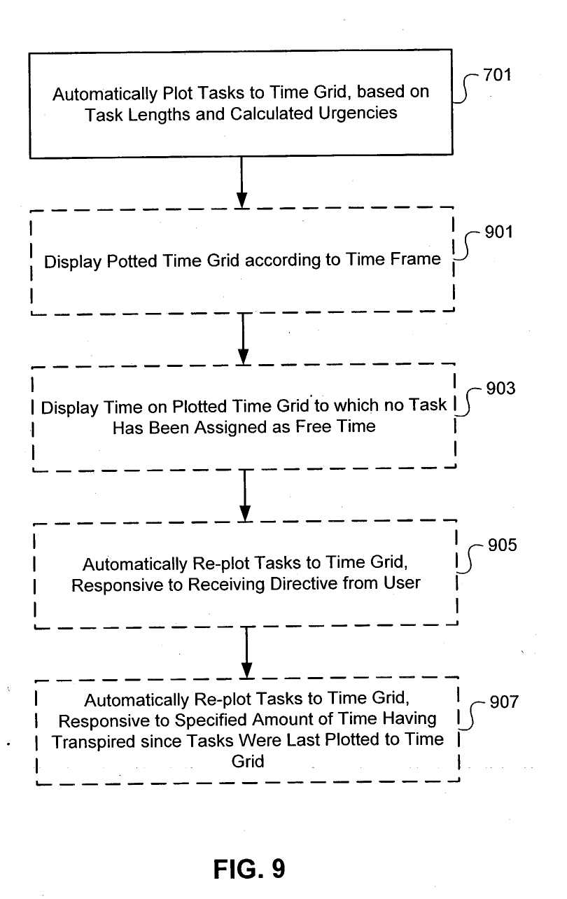

FIG. 9 illustrates steps for performing other embodiments of the present invention that include a time grid 601. The prioritization manager 101 automatically plots 701 tasks 107 to a time grid, based on lengths of the tasks 107 and the calculated urgencies 109. In some embodiments, the prioritization manager 101 displays 901 the plotted time grid 601 according to a time frame, e.g., daily, weekly or monthly. In some embodiments, the prioritization manager 101 displays 903 time on the plotted time grid 691 to which no task 107 has been assigned as free time.

In some embodiments, the prioritization manager 101 automatically re-plots 905 tasks 107 to the time grid 601, responsive to receiving a directive from the user 105 to update the time grid 601. In some embodiments, the prioritization manager 101 automatically re-plots 907 tasks 107 to the time grid 601, responsive to a specified amount of time having transpired since the tasks 107 were last plotted 701 to the time grid 601. In other words, the system 100 can be configured so that the time grid 601 is automatically re-plotted 907 every so often as desired, and/or such that the user 105 can request that the time grid 601 be re-plotted 905.

As will be understood by those familiar with the art, the invention may be embodied in other specific forms without departing from the spirit or essential characteristics thereof. Likewise, the particular naming and division of the modules, features, attributes, methodologies, managers and other aspects are not mandatory or significant, and the mechanisms that implement the invention or its features may have different names, divisions and/or formats. Furthermore, as will be apparent to one of ordinary skill in the relevant art, the modules, features, attributes, methodologies, managers and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer 103 programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

What is claimed is:

1. A computer implemented method for automatically prioritizing tasks, the method comprising:
a prioritization manager processing a plurality of tasks, each task having a plurality of associated qualities, at least some qualities having an assigned value and an associated weight;
the prioritization manager automatically calculating an urgency for at least some of the tasks, based on the assigned values and associated weights of at least some of the associated qualities; and
the prioritization manager automatically creating a structured output based on the calculated urgencies of the tasks.

2. The method of claim 1 further comprising:
the prioritization manager associating at least one quality with at least one task.

3. The method of claim 2 further comprising:
receiving a modification from a user to at least one quality associated with at least one task.

4. The method of claim 1 further comprising:
receiving an association from a user of at least one quality with at least one task.

5. The method of claim 1 further comprising:
the prioritization manager assigning at least one value to at least one quality of at least one task.

6. The method of claim 5 further comprising:
receiving a modification from a user to at least one value assigned to at least one quality of at least one task.

7. The method of claim 1 further comprising:
receiving an assignment from a user of at least one value to at least one quality of at least one task.

8. The method of claim 1 further comprising:
the prioritization manager associating at least one weight with at least one quality of at least one task.

9. The method of claim 8 further comprising:
receiving a modification from a user to at least one weight associated with at least one quality of at least one task.

10. The method of claim 1 further comprising:
receiving an association from a user of at least one weight with at least one quality of at least one task.

11. The method of claim 1 wherein a plurality of associated qualities includes at least two qualities from a group of qualities comprising:
difficulty;
importance;
type;
priority;
deadline;
length; and
completed percentage.

12. The method of claim 1 further comprising:
the prioritization manager receiving from a user a set of qualities to utilize in order to calculate an urgency for at least one task.

13. The method of claim 1 further comprising:
the prioritization manager utilizing a default set of qualities in order to calculate an urgency for at least one task.

14. The method of claim 1 wherein the prioritization manager automatically creating a structured output based on the calculated urgencies of the tasks further comprises:
the prioritization manager automatically creating a prioritized task list based on the calculated urgencies of the tasks.

15. The method of claim 14 wherein the prioritization manager automatically creating a prioritized task list based on the calculated urgencies of tasks further comprises:
the prioritization manager automatically creating a prioritized task list comprising a subset of the plurality of tasks, filtered by type.

16. The method of claim 15 wherein the subset of the plurality of tasks is filtered by a type from a group of types comprising:
employment tasks;
home tasks;
school tasks; and
personal tasks.

17. The method of claim 1 further comprising:
the prioritization manager receiving from a user a update concerning a task;
the prioritization manager automatically recalculating the urgency for that task based on the update; and
the prioritization manager automatically recreating the structured output based on the recalculated urgency.

18. The method of claim 1 wherein the prioritization manager automatically creating a structured output based on the calculated urgencies of the tasks further comprises:
the prioritization manager automatically plotting tasks to a time grid, based on lengths of the tasks and the calculated urgencies.

19. The method of claim 18 further comprising the prioritization manager displaying the plotted time grid according to a time frame from a group of time frames comprising:
daily;
weekly; and
monthly.

20. The method of claim 18 further comprising:
the prioritization manager receiving a directive concerning task scheduling from a user; and
the prioritization manager scheduling tasks according to the received directive, when automatically plotting tasks to the time grid.

21. The method of claim 20 further comprising:
the prioritization manager receiving a directive concerning task scheduling from a user, the directive specifying that tasks of a specific type are not to be scheduled during a block of time; and
the prioritization manager not scheduling the specified type of task during the block of time, when automatically plotting tasks to the time grid.

22. The method of claim 20 further comprising:
the prioritization manager receiving a directive concerning task scheduling from a user, the directive specifying that tasks of a specific type are to be scheduled during a block of time; and
the prioritization manager scheduling the specified type of task during the block of time, when automatically plotting tasks to the time grid.

23. The method of claim 20 further comprising:
the prioritization manager receiving a directive concerning task scheduling from a user, the directive specifying that no tasks are to be scheduled during a block of time; and
the prioritization manager not scheduling tasks during the block of time, when automatically plotting tasks to the time grid.

24. The method of claim 18 wherein:
at least one of the tasks that the prioritization manager plots to the time grid is designated as a recurring task.

25. The method of claim 18 further comprising:
the prioritization manager automatically re-plotting tasks to the time grid, responsive to receiving a directive from a user.

26. The method of claim 18 further comprising:
the prioritization manager automatically re-plotting tasks to the time grid, responsive to a specified amount of time having transpired since the tasks were last plotted to the time grid.

27. The method of claim 18 further comprising:
the prioritization manager displaying time on the plotted time grid to which no task has been assigned as free time.

28. A computer program product for automatically prioritizing tasks, the computer program product comprising:
program code for processing a plurality of tasks, each task having a plurality of associated qualities, at least some qualities having an assigned value and an associated weight;
program code for automatically calculating an urgency for at least some of the tasks, based on the assigned values and associated weights of at least some of the associated qualities;
program code for automatically creating a structured output based on the calculated urgencies of the tasks; and
a computer readable medium on which the program codes are stored.

29. The computer program product of claim 28 further comprising:
program code for receiving from a user a set of qualities to utilize in order to calculate an urgency for at least one task.

30. The computer program product of claim 28 further comprising:
program code for utilizing a default set of qualities in order to calculate an urgency for at least one task.

31. The computer program product of claim 28 further comprising:
program code for automatically creating a prioritized task list based on the calculated urgencies of the tasks.

32. The computer program product of claim 31 further comprising:
program code for automatically creating a prioritized task list comprising a subset of the plurality of tasks, filtered by type.

33. The computer program product of claim 28 further comprising:
program code for receiving from a user a update concerning a task;
program code for automatically recalculating the urgency for that task based on the update; and
program code for automatically recreating the structured output based on the recalculated urgency.

34. The computer program product of claim 28 further comprising:
program code for automatically plotting tasks to a time grid, based on lengths of the tasks and the calculated urgencies.

35. The computer program product of claim 34 further comprising:
program code for receiving a directive concerning task scheduling from a user; and
program code for scheduling tasks according to the received directive, when automatically plotting tasks to the time grid.

36. A computer system for automatically prioritizing tasks, the computer system comprising:
a software portion for processing a plurality of tasks, each task having a plurality of associated qualities, at least some qualities having an assigned value and an associated weight;
a software portion for automatically calculating an urgency for at least some of the tasks, based on the assigned values and associated weights of at least some of the associated qualities; and
a software portion for automatically creating a structured output based on the calculated urgencies of the tasks.

37. The computer system of claim 36 further comprising:
a software portion for receiving from a user a set of qualities to utilize in order to calculate an urgency for at least one task.

38. The computer system of claim 36 further comprising:
a software portion for utilizing a default set of qualities in order to calculate an urgency for at least one task.

39. The computer system of claim 36 further comprising:
a software portion for automatically creating a prioritized task list based on the calculated urgencies of the tasks.

40. The computer system of claim 39 further comprising:
a software portion for automatically creating a prioritized task list comprising a subset of the plurality of tasks, filtered by type.

41. The computer system of claim 36 further comprising:
a software portion for receiving from a user a update concerning a task;
a software portion for automatically recalculating the urgency for that task based on the update; and
a software portion for automatically recreating the structured output based on the recalculated urgency.

42. The computer system of claim 36 further comprising:
a software portion for automatically plotting tasks to a time grid, based on lengths of the tasks and the calculated urgencies.

43. The computer system of claim 42 further comprising:
a software portion for receiving a directive concerning task scheduling from a user; and
a software portion for scheduling tasks according to the received directive, when automatically plotting tasks to the time grid.

44. A computer system for automatically prioritizing tasks, the computer system comprising:
means for processing a plurality of tasks, each task having a plurality of associated qualities, at least some qualities having an assigned value and an associated weight;
means for automatically calculating an urgency for at least some of the tasks, based on the assigned values and associated weights of at least some of the associated qualities; and
means for automatically creating a structured output based on the calculated urgencies of the tasks.

45. The computer system of claim 44 further comprising:
means for receiving from a user a set of qualities to utilize in order to calculate an urgency for at least one task.

46. The computer system of claim 44 further comprising:
means for utilizing a default set of qualities in order to calculate an urgency for at least one task.

47. The computer system of claim 44 further comprising:
means for automatically creating a prioritized task list based on the calculated urgencies of the tasks.

48. The computer system of claim 47 further comprising:
means for automatically creating a prioritized task list comprising a subset of the plurality of tasks, filtered by type.

49. The computer system of claim 44 further comprising:
means for receiving from a user a update concerning a task;
means for automatically recalculating the urgency for that task based on the update; and
means for automatically recreating the structured output based on the recalculated urgency.

50. The computer system of claim 44 further comprising:
means for automatically plotting tasks to a time grid, based on lengths of the tasks and the calculated urgencies.

51. The computer system of claim 50 further comprising:
means for receiving a directive concerning task scheduling from a user; and
means for scheduling tasks according to the received directive, when automatically plotting tasks to the time grid.
